(19) United States
(12) Patent Application Publication
(10) Pub. No.: US 2021/0238362 A1
(43) Pub. Date: Aug. 5, 2021

(54) ARTICLE USEFUL FOR CIRCULAR ECONOMY AND COMPRISING A SILICONE ELASTOMER WITH PEELABLE AND CLEAN-RELEASING PROPERTIES

(71) Applicant: Elkem Silicones USA Corp., East Brunswick, NJ (US)

(72) Inventors: Brian PRICE, Rock Hill, SC (US); Danaya PRATCHAYANAN, Charlotte, NC (US); Yan MENG, Rock Hill, SC (US); Virginia O'NEIL, Richmond Hill, GA (US)

(21) Appl. No.: 17/161,342

(22) Filed: Jan. 28, 2021

Related U.S. Application Data
(60) Provisional application No. 62/967,984, filed on Jan. 30, 2020.

(51) Int. Cl. C08G 77/20; C08G 77/16; C08J 9/32; C08G 77/08; C09D 5/20; C09D 183/04; C08L 83/04; C08K 7/28; H01M 10/627

(52) U.S. Cl. CPC C08G 77/20; C08G 77/16; C08J 9/32; C08G 77/08; C09D 5/20; C09D 183/04; C08J 2383/04; C08K 7/28; H01M 10/627; C08G 2170/00; C08G 2150/00; C08L 2203/206; C08L 83/04

(57) ABSTRACT

The present invention relates to an article useful for circular economy which comprises of a substrate S in contact with a cured silicone elastomer Z which is peelable with clean-releasing properties and which can be easily removed by human force. The invention also relates to a recycling method comprised of peeling off the cured silicone elastomer Z from the support S of the article according to the invention and then recycling or re-using said article.

### CROSS-REFERENCE TO RELATED APPLICATIONS

This application claims the benefit of U.S. Provisional Application No. 62/967,984, filed on 30 Jan. 2020, the contents of which are hereby incorporated by reference in its entirety.

This application is also related to PCT/US2021/015444, filed 28 Jan. 2021, the content of which is incorporated herein by reference in its entirety.

### FIELD OF THE INVENTION

The present invention relates to an article useful for circular economy which comprises a substrate S in contact with a cured silicone elastomer Z which is peelable with clean-releasing properties and which can be easily removed by human force.

The invention also relates to a recycling method comprising the steps of peeling off the cured silicone elastomer Z from the support S of the article according to the invention and then recycling or re-using said article.

### BACKGROUND OF THE INVENTION

It is well known that since the industrial revolution, the world economic model has followed a linear model of value creation that begins with extraction and concludes with end-of-life disposal. Although electronic devices continue to bring huge benefits to humankind as consumer demand increases drastically, this increase had led to vast amounts of wasted resources each year. It is estimated that as much as 50 million tons of electronic and electrical waste (commonly referred as e-waste) are produced yearly. Many types of e-waste are toxic and devastating to the environment, making recycling and recovery programs critical. Furthermore, there are concerns about the availability and supply of new raw materials for electronics and electrical devices in the future. E-waste also contains many high-value and scarce materials, providing a further need and incentive for better recovery.

In electronic devices, by virtue of their diverse and excellent properties, silicone elastomers can be used in a wide variety of potting or encapsulation, bonding, sealing and coating applications against moisture, environmental contaminants and adverse environment. Unlike other organic elastomers, silicone elastomers can withstand continual temperatures up to 180° C. while maintaining their flexible properties down to −50° C. Cured silicone elastomers with adhesive properties to various substrates are indeed used for potting or encapsulating, sealing, bonding or coating with various kinds of components in harsh environments as well as high-end precision/sensitive electronic devices such as light-emitting diodes (LED), displays, photovoltaic junction boxes in solar cell modules, diodes, semiconductor devices, relays, sensors, automotive stabilizers, automotive electronic control units (ECUs), etc., mainly for insulation, moisture, dust, or shock absorption. Electronics manufacturers currently have a need for a variety of cured silicone elastomers with adhesive properties to various substrates, but all target to have a high adhesion strength to their respective substrate surfaces. With this growing technology development and a need for these cured silicone elastomers with adhesive properties to various substrates, it is expected that the demand will increase. It is however possible to use tacky silicone gels for low adhesion needs, but the low Young's modulus value often makes it hard for applicators to cleanly peel off the substrate in one piece. Adhesion is advantageous because it guarantees the protected parts from water ingress, heat, humidity and other contaminations. However, there is an emerging need for large OEMs to have either rework capability or a process for recovering key components for many of their devices. Indeed, electronic equipment re-use is seen as a positive progressive response to the shortening of product life spans, which is one of the leading factors contributing to this greater pressure on resources and manufacturing burdens. Re-use may be defined as any operation by which products or components that are not waste are used again for the same purpose for which they were conceived. Re-use occurs before the item(s) become waste. On the other hand, process for recovering key components for recyclability is often named “preparing for re-use” which means checking, cleaning or repairing recovery operations, by which products or components of products that have become waste are prepared so that they can be re-used without any other preprocessing.

This emerging need for large OEMs is also due to a powerful trend which sees linear model of production based on a take, make and dispose approach, relying on imports of virgin natural resources and disposal of wastes and emissions which appears increasingly outdated. The strength of this trend can be foreseen for example in the European Commission's Circular Economy Package (published in 2015) which aims to help European businesses and consumers to transition to a stronger and more circular economy in which resources are used in a more sustainable way. This trend is now spreading throughout the world and touches most industrialized countries.

Silicone compositions for potting or encapsulating, sealing, bonding or coating applications with adhesive properties to various substrates when cured to a silicone elastomer can now also cause challenges for many manufacturers when repair work (reuse) or recycling (“preparing for re-use”) is needed on many different devices ranging from audio-visual electronics like laptops, cellphones, computers to larger applications such as solar panels, home appliances, automotive and aerospace. It is also well known that silicone compositions for potting or encapsulating, sealing, bonding or coating applications with adhesive properties on various substrates when cured to a silicone elastomer tend to be permanent, cross-linked and irreversible, which raises particular challenges when equipment becomes obsolete or when there is a need for an upgrade or repair. Therefore, there is an urgent need for an effective means by which obsolete equipment can be disassembled and materials reclaimed for further use or repair. In most cases, a permanent (cross-linked) and highly durable silicone polymer network is developed. Adhesive bonding failures are commonly either cohesive failures or adhesive failures. A cohesive failure indicates a break within the bulk of the silicone layer, while an adhesive failure occurs at the interface between the silicone and the substrate. Such separation at the interface indicates that the silicone has peeled away from the said substrate. Whilst this is a major challenge for re-use or recycling, a solution would also offer substantial potential for innovation in temporary repair and upgrade scenarios.

The challenges described above push towards a growing need for silicone in potting or encapsulating, sealing, bonding or coating applications with adhesive properties to various is substrates. When cured to a silicone elastomer, it should be peeled off easily and cleanly once cured for reuse or recyclability purposes. Therefore, the ability to separate a cured silicone adhesive elastomer from a substrate on which it has been put in contact with, without causing damage to the said substrates, is clearly very desirable. Therefore, silicone compositions used for the above applications with such adhesive failure properties to various substrates when cured are highly desirable for reuse or recyclability purposes.

Another example of re-use need is linked to transportation which is seen as the main cause of various harmful gases being released into the atmosphere. Indeed, due to dependency on fossil fuels, conventional internal-combustion engine vehicles cause major impacts on air pollution and climate change. Achieving greenhouse gas (GHG) reduction targets requires electrification of transportation at the larger scale. A potential solution for decarbonization of the road transport sector is foreseen by shifting from Internal Combustion Engine (ICE) cars to Electric Vehicles (EVs). Electric Vehicles are developing rapidly, and their penetration is rising throughout the world. This trend relies on the heavy use of secondary batteries, in particular lithium-ion batteries, which have emerged as a key energy storage technology and are now the main technology for consumer electronics devices, industrial, transportation, and power-storage applications. Due to their high potential, energy, power densities, and good lifetime, secondary batteries are now the preferred battery technology, within the automotive industry as it is now possible to provide longer driving range and suitable acceleration for electrically propelled vehicles such as Hybrid Electric Vehicles (HEVs), Battery Electric Vehicles (BEVs) and Plug-In Hybrid Electric Vehicles (PHEVs). Within the current automotive industry, different sizes and shapes of lithium-ion battery cells are being manufactured and are subsequently assembled into packs of different configurations. An automotive secondary battery pack typically consists of many battery cells, sometimes several hundreds or thousands to meet the desired power and capacity needs. This switch in drive train technology is not, however, without its technological hurdles as the use of an electric motor translates to the need for inexpensive batteries with high energy densities, long operating lifetimes, and capability of operating in a wide range of conditions. Although rechargeable battery cells offer several advantages over disposable batteries, this type of battery is not without its drawbacks. In general, most of the disadvantages associated with rechargeable batteries are due to the battery chemistries employed, as these chemistries tend to be less stable than those used in primary cells. Secondary battery cells such as lithium-ion cells tend to be more prone to thermal management issues which occur when elevated temperatures trigger heat-generating exothermic reactions, raising the temperature further and potentially triggering more deleterious reactions. During such an event, a large amount of thermal energy is rapidly released, heating the entire cell up to a temperature of 850° C. or more. Due to the increased temperature of the cell undergoing this temperature increase, the temperature of adjacent cells within the battery pack will also increase. If the temperature of these adjacent cells is allowed to increase unimpeded, they may also enter into an unacceptable state with exceedingly high temperatures within the cell, leading to a cascading effect where the initiation of temperature increases within a single cell propagate throughout the entire battery pack. As a result, power from the battery pack is interrupted and the system employing the battery pack is more likely to incur extensive collateral damage due to the scale of damage and the associated release of thermal energy. In a worst-case scenario, the amount of generated heat is great enough to lead to the combustion of the battery as well as materials in proximity to the battery.

An important and efficient solution involving the use of silicone syntactic foam for thermally insulating secondary battery pack and further minimizing the propagation of thermal runaway is described in patent application US2018223070 filed by Elkem Silicones USA Corp. In this patent application, silicone potting products provided as silicone syntactic foams find great usage. Needless to say, the automotive industry is also facing the trends of re-use or recycling of their key components such as EV batteries which can be reused in markets that need stationary energy storage that requires less frequent cycling. Therefore, the same need for secondary electrical batteries that use silicones syntactic foams for thermal management that can be peeled off easily and cleanly for reuse or recyclability purposes will grow. Here, the ability to separate silicone syntactic foams used as potting or protecting materials with adhesive properties to various substrates without causing damage to the substrates is very desirable.

Therefore, a cured silicone elastomer Z in the form of cured silicone syntactic foam with adhesive properties to various substrates, which is peelable with clean-releasing properties and with adhesive failure properties that can be easily removed by human force would be valuable in addressing the growing gaps for repair work (reuse) or recycling (“preparing for re-use”) in these industries.

### BRIEF SUMMARY OF THE INVENTION

As a result of diligent research, the inventors of the present invention found that it was possible to solve the above-mentioned problems by providing an article comprising a substrate S in contact with a cured silicone elastomer Z with adhesive properties to various substrates and which is peelable with clean-releasing properties and wherein said cured silicone elastomer Z is prepared upon mixing and curing a curable liquid silicone composition X which is preferably stored as a two-part curable liquid silicone composition comprising a first liquid composition comprising components (A), (B), (C), (E), and eventually (F), but not (D) and a second liquid composition comprising components (A), (E), and (D), but not (B) and not (C) and not (F), wherein the first liquid composition and the second liquid composition are stored separately and comprising components:
(A) 100 parts by weight of at least one alkenyl group-containing organopolysiloxane A having at least two silicon-bonded alkenyl groups per molecule,
(B) at least one diorganohydrogensiloxy-terminated polydiorganosiloxane CE,
(C) at least one organosilicon crosslinker XL containing at least 3 silicon-bonded hydrogen atoms per molecule,
(D) at least one addition reaction catalyst D, and
(E) from 1 to 500 parts by weight of at least one filler E,
(F) from 0 to 10 parts by weight of at least one cure rate modifier F,
wherein component (A) can be the same or different in the first and second liquid compositions, and wherein component (E) can be the same or different in the first and second liquid compositions,
wherein the amounts of the alkenyl group-containing organopolysiloxane A, the diorganohydrogensiloxy-terminated polydiorganosiloxane CE, and the organosilicon crosslinker XL are determined such that:
   1) the value of the ratio RHalk is 1.00<RHalk<1.35, wherein RHalk=nH/tAlk, and wherein:
      nH=number of moles of hydrogen atom directly bonded to a silicon atom of said liquid silicone composition X; and
      tAlk=number of moles of alkenyl groups directly bonded to a silicon atom of said liquid silicone composition X, and
   2) the % molar ratio RHCE is within the range of 50%≤RHCE<98%, wherein RHCE=nHCE/(nHCE+nHXL)×100, and wherein:
      a) nHCE is the number of moles of hydrogen atom directly bonded to a silicon atom of the diorganohydrogensiloxy-terminated polydiorganosiloxane CE, and
      b) nHXL=is the number of moles of hydrogen atom directly bonded to a silicon atom of the organosilicon crosslinker XL.

An advantage of the cured silicone elastomer Z according to the invention is that it provides a material with adhesive properties to various substrates, which is peelable with clean-releasing properties and with adhesive failure properties so that it can be easily and cleanly removed by human force opening a new era for repair work (reuse) or recycling (“preparing for re-use”). Furthermore, the peel force of the cured silicone elastomer Z is from 1.5N to 23N and preferably from 3N to 23 N which is within a range that is workable for a person to peel off with their own ability. The resulting adhesive failure obtained with the use of silicone elastomer Z according to the invention yields to an interfacial bond failure between the silicone elastomer Z used as adhesive and the adherend.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements.

FIG. 1 provides a top view of a printed circuit board (PCB) coated with a cured silicone elastomer according to the invention which is peeled off easily and cleanly without causing damage to the PCB substrate.

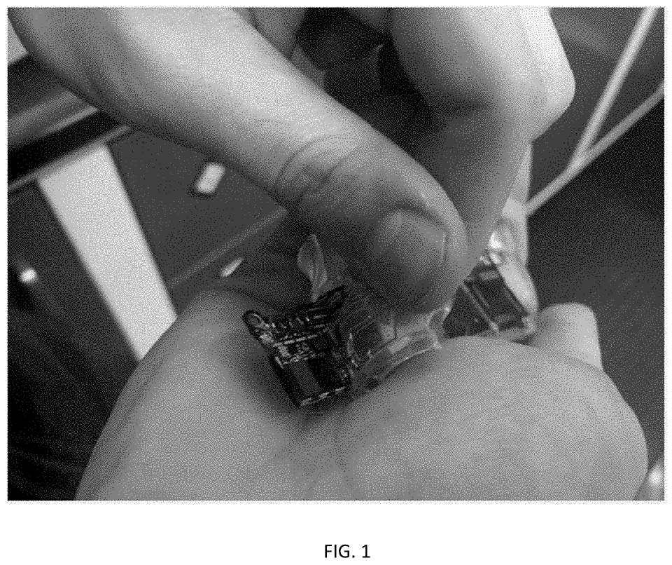

### DETAILED DESCRIPTION OF THE INVENTION

Before the subject disclosure is further described, it is to be understood that the disclosure is not limited to the particular embodiments of the disclosure described below, as variations of the particular embodiments may be made and still fall within the scope of the appended claims. It is also to be understood that the terminology employed is for the purpose of describing particular embodiments and is not intended to be limiting. Instead, the scope of the present disclosure will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this disclosure belongs.

As used herein, the terms “crosslinked” and “cured” may be used interchangeably and refer to the reaction that occurs when the two-part system is combined and allowed to react, resulting in the cured silicone elastomer.

As used herein, the term “alkenyl” is understood to mean an unsaturated, linear or branched hydrocarbon chain, substituted or not, having at least one olefinic double bond, and more preferably a single double bond. Preferably, the “alkenyl” group has 2 to 8 carbon atoms and better still 2 to 6. This hydrocarbon chain optionally includes at least one heteroatom such as O, N, S. Preferred examples of “alkenyl” groups are vinyl, allyl and homoallyl groups, vinyl being particularly preferred.

As used herein, “alkyl” denotes a saturated, linear or branched hydrocarbon chain, possibly substituted (e.g. with one or more alkyls), with preferably 1 to 10 carbon atoms, for example 1 to 8 carbon atoms and better still 1 to 4 carbon atoms. Examples of alkyl groups are notably methyl, ethyl, isopropyl, n-propyl, tert-butyl, isobutyl, n-butyl, n-pentyl, isoamyl and 1,1-dimethylpropyl.

To achieve the objective of obtaining a cured silicone elastomer Z which provides a material with adhesive properties to various substrates, which is peelable with clean-releasing properties and with adhesive failure properties so that it can be easily and cleanly removed by human force, the Applicant demonstrated, to its credit, entirely surprisingly and unexpectedly, by preparing the curable liquid silicone composition X according to the invention which has a combination of (A) an alkenyl group-containing organopolysiloxane A having at least two silicon-bonded alkenyl groups per molecule, (B) at least one diorganohydrogensiloxy-terminated polydiorganosiloxane chain extender CE, and (C) at least one organosilicon crosslinker XL containing at least 3 silicon-bonded hydrogen atoms per molecule in such amounts to result in:

1) the molar ratio of hydrogen atoms to alkenyl groups within the silicon elastomer (RHalk) are between 1.00 and 1.35, and

2) the percentage of hydrogen atoms directly bonded to a silicon atom in CE out the number of moles of hydrogen atoms directly bonded to a silicon atom in both CE and XL combined (RHCE) is between 50% and 98%

and makes it possible to overcome problems that were not solved by the prior art.

In particular, the curable liquid silicone composition X which is preferably stored as a two-part curable liquid silicone composition comprising a first liquid composition comprising components (A), (B), (C), (E), and eventually (F), but not (D) and a second liquid composition comprising components (A), (E), and (D), but not (B) and not (C) and not (F), wherein the first liquid composition and the second liquid composition are stored separately and comprising components:
(A) 100 parts by weight of at least one alkenyl group-containing organopolysiloxane A having at least two silicon-bonded alkenyl groups per molecule,
(B) at least one diorganohydrogensiloxy-terminated polydiorganosiloxane CE,
(C) at least one organosilicon crosslinker XL containing at least 3 silicon-bonded hydrogen atoms per molecule,
(D) at least one addition reaction catalyst D, and
(E) from 1 to 500 parts by weight of at least one filler E,
(F) from 0 to 10 parts by weight of at least one cure rate modifier F,
wherein component (A) can be the same or different in the first and second liquid compositions, and wherein component (E) can be the same or different in the first and second liquid compositions,
wherein the amounts of the alkenyl group-containing organopolysiloxane A, the diorganohydrogensiloxy-terminated polydiorganosiloxane CE, and the organosilicon crosslinker XL are determined such that:
   1) the value of the ratio RHalk is 1.00<RHalk<1.35, wherein RHalk=nH/tAlk, and wherein:
      nH=number of moles of hydrogen atom directly bonded to a silicon atom of said liquid silicone composition X; and
      tAlk=number of moles of alkenyl groups directly bonded to a silicon atom of said liquid silicone composition X, and
   2) the % molar ratio RHCE is within the range of 50%≤RHCE<98%, wherein RHCE=nHCE/(nHCE+nHXL)×100, and wherein:
      a) nHCE is the number of moles of hydrogen atom directly bonded to a silicon atom of the diorganohydrogensiloxy-terminated polydiorganosiloxane CE, and
      b) nHXL=is the number of moles of hydrogen atom directly bonded to a silicon atom of the organosilicon crosslinker XL.

An advantage of the cured silicone elastomer Z according to the invention is that it provides a material with adhesive properties to various substrates, which is peelable with clean-releasing properties and with adhesive failure properties so that it can be easily and cleanly removed by human force opening a new era for repair work (reuse) or recycling (“preparing for re-use”). Furthermore, the peel force of the cured silicone elastomer Z is from 1.5 N to 23 N and preferably from 3 N to 23 N which is within a range that is workable for a person to peel off with their own ability.

The amounts of the alkenyl group-containing organopolysiloxane A, the diorganohydrogensiloxy-terminated polydiorganosiloxane CE, and the organosilicon crosslinker XL included in the curable liquid silicone compositions of the invention are determined such that:

1) the molar ratio of hydrogen atoms to alkenyl groups within the silicon elastomer (RHalk) is between 1.00 and 1.35, and

2) the percentage of hydrogen atoms directly bonded to a silicon atom in CE out the number of moles of hydrogen atoms directly bonded to a silicon atom in both CE and XL combined (RHCE) is between 50 and 98%.

The molar ratio of hydrogen atoms to alkenyl groups (RHalk) can be determined using the formula:

RHalk=nH/tAlk,

in which:
nH=number of moles of hydrogen atom directly bonded to a silicon atom of the components of the curable liquid silicone composition X, and
tAlk=number of moles of alkenyl groups directly bonded to a silicon atom of the components of the curable liquid silicone composition X.

The value of RHalk in the curable liquid silicone compositions of the invention is advantageously between 1.00 and 1.35. It has been determined that if the value of RHalk is 1.00 or less, the resulting cured compositions are gel-like in structure. Similarly, if the value of RHalk is 1.35 or greater, the resulting cured compositions also tend to be gel-like in structure. Preferably, the value of RHalk in the curable liquid silicone compositions of the invention is 1.00<RHalk<1.35. Alternatively, the value of RHalk in the curable liquid silicone compositions of the invention is 1.05≤RHalk≤1.30. In another alternative, the value of RHalk in the curable liquid silicone compositions of the invention is 1.05<RHalk<1.30. In another alternative, the value of RHalk in the curable liquid silicone compositions is 1.10≤RHalk≤1.25, preferably 1.10≤RHalk<1.25, more preferably 1.10≤RHalk≤1.20.

In some embodiments, the value of the ratio RHalk is 1.10≤RHalk<1.25. In other embodiments, the value of the ratio RHalk is 1.10≤RHalk≤1.24.

In addition to the RHalk value, the molar percentage of hydrogen atoms directly bonded to a silicon atom in the diorganohydrogensiloxy-terminated polydiorganosiloxane CE to the hydrogen atoms directly bonded to a silicon atom in both CE and in the organosilicon crosslinker XL (i.e., the RHCE value) is another important feature of the curable liquid silicone compositions of the invention.

The molar percentage RHCE can be determined using the formula:

RHCE=nHCE/(nHCE+nHXL)×100

in which:
nHCE is the number of moles of hydrogen atom directly bonded to a silicon atom of the diorganohydrogensiloxy-terminated polydiorganosiloxane CE, and
nHXL=is the number of moles of hydrogen atom directly bonded to a silicon atom of the organosilicon crosslinker XL.

The value of RHCE is advantageously within the range of 50%≤RHCE<98%. It has been determined that if the value of RHCE is 98% or greater, the resulting cured compositions are gel-like in structure. If the value of RHCE is less than 50%, the resulting cured compositions become more brittle.

In a preferred embodiment, the cured silicone elastomer Z has a 180° peel adhesion to an epoxy fiberglass board within the range of 1.5 N to 23 N and preferably within the range of 3N to 23N.

In another preferred embodiment, the cured silicone elastomer Z have an elongation-at-break value of at least 200% and preferably of at least 300% measured according to ASTM D-412.

The standard ASTM D412 measures the elasticity of a material while under tensile strain, as well as its behavior after testing when the material is no longer being stressed. Though ASTM D412 measures many different properties, the following are the most common:
Tensile Strength: the maximum tensile stress applied in stretching a specimen to rupture.
Tensile Stress at a Given Elongation: the stress required to stretch the uniform cross-section of a test specimen to a given elongation.
Ultimate Elongation: the elongation at which rupture occurs in the application of continued tensile stress.
Tensile Set: the extension remaining after a specimen has been stretched and allowed to retract in a specified manner, expressed as a percentage of the original length.

The substrate S is not particularly limited, but examples thereof include a paper base substrate such as paper, a fiber base substrate such as cloth and nonwoven fabric, a plastic substrate such as a film or a sheet made of various plastics (polyolefin-based resin such as polyethylene and polypropylene, polyester-based resin such as polyethylene terephthalate, acrylic resin such as polymethyl methacrylate, and the like), and a laminate thereof. The substrate may have a form of a single layer and may also have a form of multi-layers. The substrate may be subjected to, as needed, various treatments such as a back-face treatment, an antistatic treatment, and an undercoating treatment.

Other specific examples of suitable substrates S are those used in hard/rigid printed circuit board (PCB) materials such as ceramic-based materials which include aluminum, alumina (Al₂O₃), aluminum nitride, and beryllium oxide (BeO). Other specific examples of suitable substrates S are those used in soft/flexible printed circuit board (PCB) materials useful for wearables such as polytetrafluoroethylene (PTFE), polyimide and polyetheretherketone (PEEK). Other specific examples of suitable substrates S are those used in flex-rigid printed circuit board (PCB) materials such as FR-4 which is a glass fabric-reinforced laminate bonded with flame-resistant epoxy resin.

As a preferred embodiment, the substrate S is chosen from group consisting of an element of a printed circuit board, an element of an electronic device, an element of a secondary battery pack and an element of a photovoltaic solar panels.

In a preferred embodiment, the contact between the substrate S and the cured silicone elastomer Z is done either by potting or encapsulating, coating, applying or spraying the curable liquid silicone composition X onto the substrate S and then curing it to obtain the cured silicone elastomer Z, or by potting or dipping the substrate S with said curable liquid silicone composition X and then curing it to obtain an article wherein the cured silicone elastomer Z is in contact with said substrate S.

Component (A) can be the same or different in the first and second liquid compositions. Component (E) can also be the same or different in the first and second liquid compositions.

The amounts of the alkenyl group-containing organopolysiloxane A, the diorganohydrogensiloxy-terminated polydiorganosiloxane CE, and the organosilicon crosslinker XL within the curable liquid silicone composition X are determined such that:
1) the value of the ratio RHalk is 1.00<RHalk<1.35, where RHalk=nH/tAlk, and:
   nH=number of moles of hydrogen atom directly bonded to a silicon atom of said liquid silicone composition X; and
   tAlk=number of moles of alkenyl groups directly bonded to a silicon atom of said liquid silicone composition X, and
2) the % molar ratio RHCE is within the range of 50%≤RHCE<98%, where RHCE−nHCE/(nHCE+nHXL)×100, and:
   a) nHCE is the number of moles of hydrogen atom directly bonded to a silicon atom of the diorganohydrogensiloxy-terminated polydiorganosiloxane CE, and
   b) nHXL=is the number of moles of hydrogen atom directly bonded to a silicon atom of the organosilicon crosslinker XL.

The curable liquid silicone composition of the invention comprises at least one alkenyl group-containing organopolysiloxane A having two silicon-bonded alkenyl groups per molecule. In some embodiments, the curable liquid silicone composition of the invention comprises more than one alkenyl group-containing organopolysiloxane A having two silicon-boned alkenyl groups per molecule. For example, the curable liquid silicone composition of the invention may comprise two alkenyl group-containing organopolysiloxanes A (A1 and A2) each having two silicon-bonded alkenyl groups per molecule.

In some embodiments, the at least one alkenyl group-containing organopolysiloxane A comprises:
two siloxy units of formula (A-1):

(Alk)(R)₂SiO_{1/2} (A-1)
in which: the symbol “Alk” represents a C₂ to C₂₀ alkenyl group, such as a vinyl, allyl, hexenyl, decenyl, or tetradecenyl group, preferably a vinyl group hydrogen atom, and the symbol R represents a C₁ to C₂₀ alkyl group, such as a methyl, ethyl, propyl, trifluoropropyl, or aryl group, preferably a methyl group, and
other siloxy units of formula (A-2):

(L)_{g}SiO_{(4-g)/2} (A-2)
in which the symbol L represents a C₁ to C₂₀ alkyl group, such as a methyl, ethyl, propyl, trifluoropropyl, or aryl group, preferably a methyl group, and the symbol g is equal to 0, 1, 2 or 3, in which each instance of L can be the same or different.

In some preferred embodiments, the at least one alkenyl group-containing organopolysiloxane A is of the following formula (1):

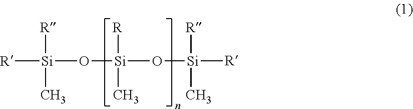

in which:
n is an integer ranging from 1 to 1000, preferably from 50 to 1000,
R is a C₁ to C₂₀ alkyl group, such as a methyl, ethyl, propyl, trifluoropropyl, or aryl group, preferably a methyl group,
R′ is a C₂ to C₂₀ alkenyl group, such as a vinyl, allyl, hexenyl, decenyl, or tetradecenyl group, preferably a vinyl group, and
R″ is a C₁ to C₂₀ alkyl group, such as a methyl, ethyl, propyl, trifluoropropyl, or aryl group, preferably a methyl group.

In a preferred embodiment, the at least one alkenyl group-containing organopolysiloxane A is one or more α,ω-(vinydimethylsilyl)polydimethylsiloxane(s), more preferably, one or more linear α,ω-(vinyldimethylsilyl)polydimethylsiloxane(s).

All the viscosities under consideration in the present specification correspond to a dynamic viscosity magnitude that is measured, in a manner known per se, at 25° C., with a machine of Brookfield type. As regards to fluid products, the viscosity under consideration in the present specification is the dynamic viscosity at 25° C., known as the “Newtonian” viscosity, i.e. the dynamic viscosity that is measured, in a manner known per se, at a sufficiently low shear rate gradient so that the viscosity measured is independent of the rate gradient.

In some embodiments, the viscosity of the at least one alkenyl group-containing organopolysiloxane A is between about 50 to about 100,000 mPa·s., preferably between about 100 to about 80,000 mPa·s., more preferably between about 100 to about 65,000 mPa·s.

In some embodiments, the molecular weight of the at least one alkenyl group-containing organopolysiloxane A is between about 1,000 g/mol to about 80,000 g/mol, preferably between about 10,000 g/mol to about 70,000 g/mol.

In another preferred embodiment, the at least one alkenyl group-containing organopolysiloxane A is preferably linear.

The curable liquid silicone composition of the invention comprises at least one organosilicon crosslinker XL containing at least 3 silicon-bonded hydrogen atoms per molecule. In some embodiments, the organosilicon crosslinker XL containing at least 3 silicon-bonded hydrogen atoms per molecule is an organohydrogenpolysiloxane comprising from 10 to 500 silicon atoms within each molecule, preferably from 10 to 250 silicon atoms within each molecule.

In a preferred embodiment, the organosilicon crosslinker XL is selected such that the ratio α (d/(ΣSi)) is within the range 0.01≤α≤0.957, in which d=number of H atoms directly linked to a Si atom per molecule, and ΣSi is the sum of silicon atoms per molecule. In a preferred embodiment, the ratio α is within the range 0.10≤α≤0.75. In other preferred embodiments, the ratio α is within the range 0.10≤α≤0.30.

In some embodiments, the organosilicon crosslinker XL containing at least 3 silicon-bonded hydrogen atoms per molecule is an organohydrogenpolysiloxane comprising from 10 to 500 silicon atoms within each molecule, and the ratio α is within the range 0.01≤α≤0.957, where α=d/(ΣSi), and:
d=number of H atoms directly linked to a Si atom per molecule, and
ΣSi is the sum of silicon atoms per molecule.

In some embodiments, the organosilicon crosslinker XL containing at least 3 silicon-bonded hydrogen atoms per molecule is an organohydrogenpolysiloxane comprising from 10 to 250 silicon atoms within each molecule and the ratio α is within in the range of 0.10≤α≤0.75.

The at least one organosilicon crosslinker XL can be included in the curable liquid silicone composition in an amount from about 0.01% to about 10%, preferably from about 0.05% to about 5%, preferably from about 0.1% to about 4% by weight of the total composition.

In some embodiments, the organosilicon crosslinker XL containing at least 3 silicon-bonded hydrogen atoms per molecule is an organohydrogenpolysiloxane comprising from 0.45% to 40% SiH by weight, more preferably between 0.5% to 35% SiH by weight, more preferably between 0.5% to 15% SiH by weight or between 5% to 12% SiH by weight

In some embodiments, the organosilicon crosslinker XL comprises:
(i) at least 3 siloxy units of formula (XL-1) which may be identical or different:

(H)(Z)ₑSiO_{(3-e)/2} (XL-1)

in which:
the symbol H represents a hydrogen atom,
the symbol Z represents an alkyl having from 1 to 8 carbon atoms inclusive, and
the symbol e is equal to 0, 1 or 2, preferably e is equal to 1 or 2; and (ii) at least one, and preferably from 1 to 550 of siloxy unit(s) of formula (XL-2):

(Z)_{g}SiO_{(4-g)/2} (XL-2)

in which:
the symbol Z represents an alkyl having from 1 to 8 carbon atoms inclusive, and
the symbol g is equal to 0, 1, 2 or 3, preferably g is equal to 2;

in which Z in XL-1 and XL-2 can be the same or different.

In some embodiments, the symbol Z is selected from methyl, ethyl, propyl and 3,3,3-trifluoropropyl groups, cycloalkyl groups, and aryl groups. In some embodiments, Z is a cycloalkyl group selected from cyclohexyl, cycloheptyl, and cyclooctyl groups. In other embodiments, Z is an aryl group selected from the group consisting of xylyl, tolyl, and phenyl groups. In other embodiments, Z is a methyl group.

In a preferred embodiment, the symbol “e” in XL-1 is 1 or 2. In a preferred embodiment, the symbol “g” in XL-2 is 2. In a preferred embodiment, the organosilicon crosslinker XL comprises from 3 to 60 siloxy units of formula (XL-1) and from 1 to 250 siloxy unit(s) of formula (XL-2).

In some embodiments, the organosilicon crosslinker XL comprises from 3 to 60 siloxy units of formula (XL-1) and from 1 to 250 siloxy unit(s) of formula (XL-2).

The curable liquid silicone composition of the invention further comprises at least one diorganohydrogensiloxy-terminated polydiorganosiloxane chain extender CE. The at least one diorganohydrogensiloxy-terminated polydiorganosiloxane chain extender CE can be included in the curable liquid silicone composition in an amount from about 0.1% to about 20%, preferably from about 0.5% to about 15%, preferably from about 0.5% to about 10% by weight of the total composition.

In some embodiments, the diorganohydrogensiloxy-terminated polydiorganosiloxane CE is of the following formula (2):

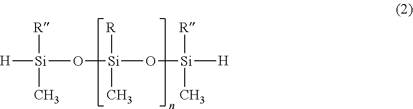

in which:
R and R″ are independently a C₁ to C₂₀ alkyl group, preferably R and R″ are independently chosen from the group consisting of: methyl, ethyl, propyl, trifluoropropyl and aryl, and most preferably R and R″ are methyl, and
n is an integer ranging from 1 to 500, preferably from 2 to 100, and more preferably from 3 to 50.

In some embodiments, the viscosity of the at least one diorganohydrogensiloxy-terminated polydiorganosiloxane CE is between about 1 to about 500 mPa·s., preferably between about 2 to about 100 mPa·s., more preferably between about 4 to about 50 mPa·s, or between about 5 to about 20 mPa·s.

In some embodiments, the molecular weight of the at least one diorganohydrogensiloxy-terminated polydiorganosiloxane CE is between about 100 g/mol to about 5,000 g/mol, preferably between about 250 g/mol to about 2,500 g/mol, more preferably between about 500 g/mol to about 1,000 g/mol.

In some embodiments, the diorganohydrogensiloxy-terminated polydiorganosiloxane CE is of the following formula (2):

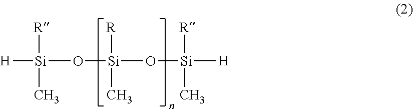

in which:
R and R″ are independent and are selected from a C₁ to C₂₀ alkyl group, and
n is an integer ranging from 1 to 500, preferably n is an integer ranging from 2 to 100, more preferably n is an integer ranging from 3 to 50.

In some embodiments, R and R″ are independently selected from methyl, ethyl, propyl, trifluoropropyl and phenyl. Preferably, R and R″ are methyl.

The liquid curable silicone composition of the invention further comprises at least one addition reaction catalyst D. The addition reaction catalyst D can be included at any amount capable of curing the composition. For example, the addition reaction catalyst D can be included at an amount where the quantity of a platinum group metal in catalyst D is from 0.01 to 500 parts per weight per 1,000,000 parts by weight of the alkenyl group-containing organopolysiloxane A. The catalyst D may notably be chosen from compounds of platinum and rhodium. It is possible, in particular, to use platinum complexes and an organic product described in U.S. Pat. Nos. 3,159,601, 3,159,602, 3,220,972 and European patents EP-A-0 057 459, EP-A-0118 978 and EP-A-0190 530, complexes of platinum and vinylorganosiloxanes described in U.S. Pat. Nos. 3,419,593, 3,715,334, 3,377,432 and 3,814,730.

In a preferred embodiment, the addition reaction catalyst D is a platinum group metal-containing catalyst.

To achieve good physical properties, a filler E is present within the curable liquid silicone composition X.

In some embodiments, the filler E is selected from the group consisting of a reinforcing filler E1, a thermally conductive filler E2, an electrically conductive filler E3, hollow glass beads E4 and mixtures thereof.

An example of a suitable filler E is hydrophobic silica aerogel which is a nanostructured material with high specific surface area, high porosity, low density, low dielectric constant and excellent heat insulation properties. Silica aerogels are synthesized either via supercritical drying process or via ambient pressure drying technique so as to obtain porous structure. It is now widely commercially available. Hydrophobic silica aerogel is characterized by a surface area ranging of from 500 to 1500 m²/g, alternatively of from 500 to 1200 m²/g, in each case determined via the BET method. The hydrophobic silica aerogel may further be characterized by its porosity above 80%, alternatively above 90%. Hydrophobic silica aerogel may have an average particle size ranging from 5 v to 1000 μm, alternatively of from 5 μm to 100 μm, alternatively of from 5 μm to 25 μm as measured by means of laser light scattering. An example of hydrophobic silica aerogel is a trimethyl silylated aerogel. The hydrophobic silica aerogel maybe presents in the curable liquid silicone rubber composition in an amount of from 1 to 30% weight relative to the total weight of the curable liquid silicone rubber.

Another example of a suitable filler E is alumina. A highly dispersible alumina is advantageously employed, doped or not in a known manner. It is of course possible also to use cuts of various aluminas. As non-limiting examples of such aluminas, reference may be made to aluminas A 125, CR 125, D 65CR from the Baikowski Company.

As regards weight, it is preferred to employ a quantity of reinforcing filler E of between 5% and 30%, preferably between 6 and 25% and more preferably between 7 and 20% by weight based on all the constituents of the composition.

In some embodiments, the filler E is present in the curable liquid silicone composition X in an amount from 1 to 100 parts by weight, from 1 to 50 parts by weight, or from 1 to 25 parts is by weight.

An example of a suitable reinforcing filler E1 is silicas, in particular silicas which are characterized by a fine particle size often less than or equal to 0.1 μm and a high ratio of specific surface area to weight, generally lying within the range of approximately 50 square meters per gram to more than 300 square meters per gram. Silicas of this type are commercially available products and are well known in the art of the manufacture of adhesive silicone compositions. These silicas may be colloidal silicas, silicas prepared pyrogenically (silicas called combustion or fumed silicas) or by wet methods (precipitated silicas) of mixtures of these silicas. The chemical nature and the method for preparing silicas capable of forming the reinforcing filler E1 are not Important for the purpose of the present invention, provided the silica is capable of exerting a reinforcing action on the final adhesive. Cuts of various silicas may of course also be used. These silica powders have a mean particle size generally close to or equal to 0.1 μm and a BET specific surface area 5 greater than 50 m²/g, preferably between 50 and 400 m²/g, notably between 150 and 350 m²/g. These silicas are optionally:
pretreated with the aid of at least one compatibilizing agent chosen from the group of molecules that satisfy at least two criteria:
   1) have a high interaction with silica in the region of its hydrogen bonds with itself and with the surrounding silicone oil; and
   2) are themselves, or their degradation products, easily removed from the final mixture by heating under vacuum in a gas flow, and compounds of low molecular weight are preferred;
and/or treated in situ:
   in a specific manner with the aid of at least one untreated silica,
   and/or in a complementary manner by using at least one compatibilization agent of nature similar to that which can be used in pre-treatment and as defined above.

In situ treatment of the silica filler is understood to mean putting the filler and the compatibilizing agent in the presence of at least one portion of the preponderant silicone polymer referred to above. The compatibilizing agent is chosen according to the treatment method (pre-treatment or in situ) and may for example be selected from the group comprising: chlorosilanes, polyorganocyclosiloxanes, such as octamethylcyclosiloxane (D4), silazanes, preferably disilazanes, or mixtures thereof, hexamethyldisilazane (HMDZ) being the preferred silazane, polyorganosiloxanes having, per molecule, one or more hydroxyl groups linked to silicon, amines such as ammonia or alkylamines with a low molecular weight such as diethylamine, organic acids with a low molecular weight such as formic or acetic acids and mixtures thereof. In the case of in situ treatment, the compatibilizing agent is preferably used in the presence of water. For more details in this respect, reference may be made for example to patent FR-B-2 764 894. As a variant, it is possible to use compatibilizing methods of the prior art providing early treatment by silazane (e.g. FR-A-2 320 324) or a delayed treatment (e.g. EP-A-462 032) bearing in mind that according to the silica used their use will in general not make it possible to obtain the best results in terms of mechanical properties, in particular extensibility, obtained by treatment on two occasions according to the invention.

In a preferred embodiment, the compatilizing agent is hexamethyldisilazane (HMDZ).

The amount of finely divided silica or other reinforcing filler E1 used in the curable liquid silicone composition X of the present invention is at least in part determined by the physical properties desired in the cured elastomer. The curable liquid silicone composition X of the present invention typically comprises from 5 to 100 parts, typically from 10 to 60 parts by weight of a reinforcing filler for every 100 parts of organopolysiloxane A.

In some embodiments, the reinforcing filler E1 is selected from silicas and/or aluminas, preferably selected from silicas.

Examples of thermally conductive filler E2 include, but are not limited to, aluminum oxide, aluminum nitride, boron nitride, diamond, magnesium oxide, zinc oxide, zirconium oxide, silver, gold, copper, and combinations thereof. Other examples include one or more types of powders and/or fibers selected from a group including pure metals, alloys, metal oxides, metal hydroxides, metal nitrides, metal carbides, metal silicides, carbon, soft magnetic alloys, and ferrite. Examples of pure metals include bismuth, lead, tin, antimony, indium, cadmium, zinc, silver, copper, nickel, aluminum, iron, and metal silicon. Examples of alloys include alloys consisting of two or more types of metals selected from a group including bismuth, lead, tin, antimony, indium, cadmium, zinc, silver, aluminum, iron, and metal silicon. Examples of the metal oxide include alumina, zinc oxide, silicon oxide, magnesium oxide, beryllium oxide, chromium oxide, or titanium oxide. Examples of the metal hydroxide include magnesium hydroxide, aluminum hydroxide, barium hydroxide, or calcium hydroxide. Examples of the metal nitride is boron nitride, aluminum nitride, or silicon nitride. Examples of metal carbides include boron carbide, silicon carbide and titanium carbide. Examples of metal silicides include titanium silicide, tungsten silicide, zirconium silicide, tantalum silicide, magnesium silicide, niobium silicide, chromium silicide and molybdenum silicide. Examples of carbon include amorphous carbon black, carbon nanotubes, graphene, diamond, graphite, fullerene, and activated carbon. In a preferred embodiment, the thermally conductive filler E2 is preferably chosen from the group consisting of a silver powder, graphite, aluminum oxide powder, zinc oxide powder, aluminum powder, aluminum nitride powder and mixtures thereof.

Examples of electrically conductive fillers E3 may include, but are not limited to, carbon black, graphite, single-wall carbon nanotubes, multi-wall carbon nanotubes, double-wall carbon nanotubes, silver and/or silver chloride coated structures, such as nano-wires, metal fibers, metal nanoparticles, metal microplates, glass and/or silica microparticles, microplates and/or is beads coated with a conductive material, and/or any other appropriate fillers, additives, modifications and/or combinations thereof. Particulate and micro particulate conductive materials that create electrical conductivity in the cured silicone are exemplified by powders and micro powders of gold, copper, silver, nickel, and the like, as well as alloys containing at least one of the foregoing metals; and by the powders and micro powders fabricated by the vacuum deposition, or plating, of a metal such as gold, silver, nickel, copper, and their alloys, and the like, onto the surface of a ceramic, glass, quartz, or organic resin micropowder, and the like. Examples of fillers that fit the above descriptions are silver, silver-coated aluminum, silver-coated copper, silver-coated solid, silver-coated ceramic, silver-plated nickel, nickel, nickel-coated graphite, carbon, and the like.

Hollow glass beads E4 may be added to the composition according to the invention which when cured yields to a silicone syntactic foam and allows to reduce the density of the foam. By “silicone syntactic foam” it is meant a matrix made of cured silicone elastomer in which is dispersed hollow glass beads. Hollow glass beads, and in particular hollow glass microspheres are well suited for this purpose because, in addition to having excellent isotropic compressive strengths, they have the lowest density of any filler that would be useful in the manufacture of high compressive strength syntactic foam. The combination of high compressive strength and low density make hollow glass microspheres a filler with numerous advantages according to the invention. According to one embodiment, hollow glass beads are hollow borosilicate glass microspheres also known as glass bubbles or glass microbubbles. According to another embodiment, the hollow borosilicate glass microspheres have true densities ranging from 0.10 gram per cubic centimeter (g/cc) to 0.65 gram per cubic centimeter (g/cc). The terms “true density” is the quotient obtained by dividing the mass of a sample of glass bubbles by the true volume of that mass of glass bubbles as measured by a gas pycnometer. The “true volume” is the aggregate total volume of the glass bubbles, not the bulk volume.

According to a preferred embodiment the cured silicone elastomer Z of the article according to the invention is a silicone syntactic foam comprising of hollow glass beads E4.

According to another embodiment, the level of the hollow glass beads E4 is up to 50% volume loading in the silicone syntactic foam or of the liquid crosslinkable silicone composition precursor of said silicone syntactic foam, and most preferably between 5% and 50% by volume of the silicone syntactic foam or of the liquid curable silicone composition precursor of said silicone syntactic foam as described below.

According to a preferred embodiment, Hollow glass beads E4 are chosen from the 3M™ Glass Bubbles Floated Series (A16/500, G18, A20/1000, H20/1000, D32/4500 and H50/10,000EPX glass bubbles products) and 3M™ Glass Bubbles Series (such as but not limited to K1, K15, S15, S22, K20, K25, S32, S35, K37, XLD3000, S38, S38HS, S38XHS, K46, K42HS, S42XHS, S60, S60HS, iM16K, iM30K glass bubbles products) sold by 3M Company. Said glass bubbles exhibit various crush strengths ranging from 1.72 megapascal (250 psi) to 186.15 Megapascals (27,000 psi) at which ten percent by volume of the first plurality of glass bubbles collapses. Other glass bubbles sold by 3M such as 3M™ Glass Bubbles—Floated Series, 3M™ Glass Bubbles—HGS Series and 3M™ Glass Bubbles with Surface Treatment could also be used according to the invention.

According to a preferred embodiment said hollow glass beads E4 are chosen among those exhibiting crush strengths ranging from 1.72 megapascal (250 psi) to 186.15 Megapascals (27,000 psi) at which ten percent by volume of the first plurality of glass bubbles collapses.

According to a most preferred embodiment, hollow glass beads are chosen from the 3M™ Glass Bubbles series, S15, K1, K25, iM16K, S32 and XLD3000.

In some embodiments, the cure rate modifier F is a crosslinking inhibitor F1 and/or a crosslinking retardant F2. In some embodiments, the cure rate modifier F is present in an amount from 0.001 to 5 parts by weight, from 0.005 to 2 parts by weight, or from 0.01 to 0.5 parts by weight.

In some embodiments, the two-part curable liquid silicone composition further comprises component(s):
(G) from 0 to 2 parts by weight of at least one thickener 01 or at least one rheology modifier G2, and/or
(H) from 0 to 10 parts of at least one additive H.

In some embodiments, components (G) and (H) are not present in the two-part curable liquid silicone composition of the invention.

The silicone elastomers of the invention may also contain at least one cure rate modifier F. The cure rate modifier F may be a crosslinking inhibitor F1 and/or a crosslinking retardant F2, for example.

Crosslinking inhibitors are also well known. Examples of crosslinking inhibitors F1 that may be used as the cure rate modifier F include:
polyorganosiloxanes, advantageously cyclic and substituted by at least one alkenyl group, tetramethylvinyttetrasiloxane being particularly preferred,
pyridine,
phosphine and organic phosphites,
unsaturated amides,
alkylated maleates, or
acetylenic alcohols.

These acetylenic alcohols (cf. FR-B-1 528 464 and FR-A-2 372 874), which form part of the preferred thermal blockers of the hydrosilylation reaction, have the formula:

R—C(R′)(OH)—C≡CH

in which:
R is a linear or branched alkyl radical, or a phenyl radical;
R′ is H or a linear or branched alkyl radical, or phenyl radical;
and the radicals R, R′ and the carbon atom situated in the alpha position of the triple bond being possibly able to form a ring; the total number of carbon atoms contained in R and R′ being at least 5, preferably 9 to 20.

Said alcohols are preferably chosen from those having a boiling point about 250° C. As examples, mention may be made of:
ethynyl-1-cyclohexanol (ECH);
methyl-3 dodecyne-1 oi-3;
trimethyl-3,7,11 dodecyne-1 ol-3;
diphenyl-1,1 propyne-2 ol-1
ethyl-3 ethyl-6 nonyne ol-3;
methyl-3 pentadecyne-1 oi-3.

These alpha-acetylenic alcohols are commercial products. Such a regulator is present at a maximum of 2,000 ppm, preferably in an amount of from 20 to 50 ppm based on the total weight of organopolysiloxanes A, CE, and XL.

Examples of crosslinking retardants F2 that may be used as the cure rate modifier F include so-called inhibitors for controlling the crosslinking reaction and extending the pot life of the silicone composition. Examples of advantageous crosslinking retardants F2 that may be used as the cure rate modifier F include, for example, vinylsiloxanes, 1,3-divinytetra-methyldi siloxane, or tetravinyl-tetramethyl-tetracyclosiloxanes. It is also possible to use other known inhibitors, for example ethynylcyclohexanol, 3-methylbutynol, or dimethyl maleate.

The curable liquid silicone compositions of the invention may also contain one or more of the following optional components, at least one thickener 01 or at least one rheology modifier G2, and/or at least one additive H normally used in the field of the invention.

Rheology modifiers G2 can improve rheological properties, to provide higher flow and smooth surfaces of the shaped articles. Such rheology modifiers G2 can be PTFE-powders, boron oxide derivatives, flow additives like fatty acid fatty alcohol derivatives or derivative, esters and its salts or fluoroalkyl surfactants.

Examples of additives H that may be used include organic dyes or pigments, stabilizers introduced in silicone elastomer in order to improve heat stability, resistance against hot air, reversion, depolymerisation under attack of traces of acids or water at high temperature. Plasticizers, or release oils, or hydrophobicizing oils, such as polydimethylsiloxane oils, without reactive alkenyl or SiH groups. Mold-release such as fatty acid derivatives or fatty alcohol derivatives, fluoroalkyl. Compatibilizer such as hydroxylated silicone oils. Adhesion promoters and adhesion modifiers such organic silanes.

Upon mixing the first liquid composition and the second liquid composition of the two-part system, the curable liquid silicone compositions may be cured at any suitable temperature by any suitable method. For example, the first liquid composition and the second liquid composition of the two-part system may be cured at room temperature (approximately 20-25° C.) or at higher temperatures. In some embodiments, the first liquid composition and the second liquid composition of the two-part system may be cured at 50° C. or higher, at 80° C. or higher, at 100° C. or higher, at 120° C. or higher, at 150° C. or higher. In some embodiments, the first liquid composition and the second liquid composition are cured at room temperature upon mixing.

The curing reaction between the first liquid composition and the second liquid composition may proceed for any length of time necessary to obtain a suitable cured silicone elastomer according to the invention. One of skill in the art will immediately appreciate that the length of the reaction may vary depending on the temperature of the reaction among other variables. In some embodiments, the first liquid composition and the second liquid composition are cured for about one day at room temperature. In other embodiments, the first liquid composition and the second liquid composition are cured for about ten minutes at 2 100° C.

In a preferred embodiment, the components of the curable silicone composition X according to the invention are chosen so as to get a viscosity of said composition up to 10,000 mPa·s at 25° C., preferably between about 500 mPa·s to about 10,000 mPa·s at 25° C., and even more preferably between 1000 mPa·s to about 8,000 mPa·s at 25° C.

Another object of the invention concerns a recycling method comprising the steps of:

a) providing an article according to the invention and as described above,
b) peeling off the cured silicone elastomer Z from the support S, and then
c) recycling or re-using said article.

As the cured silicone elastomer Z according to the invention provides a material with adhesive properties to various substrates, which is peelable with clean-releasing properties and with adhesive failure properties, it can be easily and cleanly removed by human force. Repair work (reuse) or recycling (“preparing for re-use”) could be therefore easily performed when applying the recycling method according to the invention. The peel force of the cured silicone elastomer Z is from 3N to 23 N which is within a range that is workable for a person to peel off with their own ability.

The recycling method according to the invention is an adapted response to the emerging need for large OEMs to have either rework capability or a process for recovering key components for many of their devices.

In a preferred embodiment of the recycling method according to the invention, the article is a printed circuit board (PCB), an electronic device, a secondary battery pack or a photovoltaic solar panel.

In a preferred embodiment, the invention concerns a recycling method wherein the article is a secondary battery pack comprising a substrate S in contact with a cured silicone elastomer Z which is a silicone syntactic foam comprising hollow glass beads E4 according the invention and as described above.

In a preferred embodiment, the invention concerns a recycling method comprising the steps of:
a) providing an article which is a secondary battery pack comprising a substrate S in contact with a cured silicone elastomer Z which is a silicone syntactic foam comprising hollow glass beads E4 according the invention and as described above,
b) peeling off the cured silicone elastomer Z from the support S, and then
c) re-using said secondary battery pack for stationary energy storage.

The recycling method described in this invention will greatly benefit from the use of silicone syntactic foam according to the invention for thermally insulating secondary battery pack which has been found to minimize the propagation of thermal runaway as described in patent application US2018223070. Indeed, a typical EV lithium ion battery pack has a useful first life of around 250,000 km, although fast charging accelerates battery degradation as a result of higher required charging currents. When, the automotive battery pack loses from 15% to 20% of its initial capacity it becomes unfit for traction as the lower capacity of battery affects acceleration, range and regeneration capabilities of the vehicle. The possibility to reuse the batteries at the end of their automotive lifecycle for stationary energy storage for example as part of a smart grid to provide energy storage systems (ESS) for load leveling, residential or commercial power, is a key step toward circular economy. The potential impact of battery reuse on life cycle greenhouse gas emissions and energy usage of the battery in first and second uses is also a key advantage linked to the use of the recycling method according to the invention.

By using the recycling method according to the invention, the silicone syntactic foam according to the invention may-be easily and cleanly peeled-off from the battery pack allowing collecting and via testing infrastructure selecting batteries which have between 80-85% of their original capacity for re-use purpose, and the others for recycling purpose to recover key raw materials such as cobalt, lithium, copper, graphite, nickel, aluminum, and manganese.

The recycling method according to the invention is also suitable for photovoltaic solar panels such as Monocrystalline Silicon Cells (mono-Si) and Polycrystalline Silicon Cells (multi-Si).

Other advantages provided by the present invention will become apparent from the following illustrative examples.

### EXAMPLES

### Preparation of the Silicone Compositions:

In the examples below, the following components are used:
Component A1: Alkenyl group-containing organopolysiloxane A having at least two silicon-bonded alkenyl groups per molecule=polydimethylsiloxane with dimethylvinylsilyl end-units with a viscosity at 25° C. ranging from 500 mPa·s to 650 mPa·s (Mn≈10250 g/mol).
Component A2: Linear α,ω-vinyl polydimethylsiloxanes (average viscosity of 20000 mPa·s; Mn≈49,000 g/mol).
Component B: Diorganohydrogensiloxy-terminated polydiorganosiloxane CE=α,ω-hydride polydimethylsiloxanes (H-PDMS-H) (viscosity of 7-10 mPa·s; Mn≈750 g/mol)
Component C: Copolymer of dimethylsiloxane and methylhydrogensiloxane partially capped at both molecular terminals with di-methylhydrogensiloxy groups (viscosity of 28-32 mPa·s; 6.4-8.2% SiH by weight (XL)
Component D: Platinum catalyst solution: platinum metal diluted in short linear α,ω-vinyl polydimethylsiloxane oils (weight % in platinum=10).
Component E: In situ treated hydrophilic fumed silica (AEROSIL® 300 treated with hexamethyldisilazane).
Component E1: Hollow glass: 3MT™ Glass Bubbles Series K25, sold by 3M Company glass bubbles with a density of 0.25 g/cc and an isostatic crush strength of 750 psi.
Component F: ECH (1-Ethynyl-1-cyclohexanol).
Component E2: Martoxid™-3310 aluminum oxide powder (thermally conductive filler sold by Huber.
Component LSR Base: 63.6% by weight of component A2+26.3% of hydrophilic fumed silica (AEROSIL® 300), 2.5% by weight of water and 7.6% by weight of hexamethyl disilazane (In situ treated hydrophilic fumed silica).
Component LSR Base 2: Prepared according to Example 1 of U.S. Pat. No. 8,927,627 (preparation described for “additive of LSR base type”).
Formulation ESA-7244=Bluesil™ ESA 7244 A & B sold by Elkem Silicones is a liquid two-component, polyaddition heat curing silicone elastomer; Ratio: RHalk=1.24; In this formulation there is no diorganohydrogensiloxy-terminated polydiorganosiloxane CE chain extender; so the ratio: RHCE (%)=0.
Formulation ESA 7242=Bluesil™ ESA 7242 A & B sold by Elkem Silicones is a liquid two-component, polyaddition heat curing silicone elastomer; Ratio: RHalk=1.19; In this formulation there is no diorganohydrogensiloxy-terminated polydiorganosiloxane CE chain extender; and the ratio: RHCE (%)=0.
Formulation ESA 6009=Bluesil™ ESA 6009 A & B sold by Elkem Silicones is a liquid two-component, polyaddition heat curing silicone gel; Ratio: RHalk=0.64; Ratio: RHCE (%)=34.
   Substrate S: Printed circuit board (PCB) which is composed of solely bare fiberglass

### Procedure for Preparing the Formulations:

The formulations quoted below were prepared by mixing parts A & B in a 1:1 weight ratio. The resulting mixture were then each applied at 1 mm thick onto substrate S (PCB) and were cured at 120° C. for 15 minutes onto the substrate S and left to cool for 12 hours. The substrate S coated with the resulting cured elastomer were cut with a knife cutter to have a width of 25.4 mm (1 inch); allowing 4 total pieces to be peeled off. Each strip was clamped and pulled at a rate of 304.8 mm/min (12 inch/min) at ambient temperature and their force averaged were recorded. From this testing we recorded quantitative results and observed visual tearing when the material was too weak.
Standard ASTM D-412 method with specimen dimensions ASTM D-412 Die C were used for tensile, modulus, and elongation at break. ASTM D-624 Die A was used for tear testing. ASTM D-2240 was used for hardness testing,
   Peel Test: Standard ASTM D-903 was referenced with modifications on substrate that was used to peel, bond line thickness (copper shims were used) and the peel force rate.
   Mechanical properties were measured after mixing 1:1 by weight of Part-A and Part-B of each composition tested, coating a 1 mm thick coating on a PCB board and curing at 120° C. for 15 minutes and left to cool for 12 hours.

TABLE 1
Formulations breakdown (components are listed by % weight)

| Examples | Ex. 1 | Ex. 2 | Ex. 3 | Ex. 4 | Ex. 5 | Ex. 6 | Ex. 7 | Ex. 8 |
|---|---|---|---|---|---|---|---|---|
| Ratio: RHalk | 1.20 | 1.20 | 1.20 | 1.20 | 1.20 | 1.20 | 1.20 | 1.20 |
| Ratio: RHCE (%) | 75 | 95 | 85 | 65 | 55 | 75 | 75 | 75 |
| Components | Part A (in part) | | | | | | | |
| Component: LSR Base | 32.92 | 32.88 | 32.93 | 33.03 | 32.87 | 13.96 | 23.41 | 47.56 |
| Component A1 | 67.04 | 67.08 | 67.03 | 66.93 | 67.09 | 86.00 | 76.55 | 52.40 |
| Component D | 0.04 | 0.04 | 0.04 | 0.04 | 0.04 | 0.04 | 0.04 | 0.04 |
| Total Part A By Weight % | 100 | 100 | 100 | 100 | 100 | 100 | 100 | 100 |
| LSR Base | 32.92 | 32.74 | 32.49 | 32.00 | 31.95 | 13.58 | 22.83 | 46.67 |
| Component A1 | 55.51 | 55.25 | 55.88 | 57.20 | 57.47 | 72.93 | 64.79 | 43.81 |
| Component F | 0.03 | 0.03 | 0.03 | 0.03 | 0.03 | 0.03 | 0.03 | 0.03 |
| Component XL | 2.26 | 0.46 | 1.37 | 3.15 | 4.04 | 2.72 | 2.49 | 1.92 |
| Component CE | 9.28 | 11.52 | 10.23 | 7.70 | 6.51 | 10.74 | 9.86 | 7.58 |
| Total Part B By Weight % | 100 | 100 | 100 | 100 | 100 | 100 | 100 | 100 |
| Viscosity (mPa · s) just | 6600 | 3200 | 3200 | 3200 | 3200 | 1200 | 2000 | 8800 |
| after mixing 1:1 by | | | | | | | | |
| weight of part A and | | | | | | | | |
| Part B | | | | | | | | |
| | Mechanical properties: after mixing 1:1 by weight of Part-A and Part-B, coating a 1 mm thick | | | | | | | |
| Application tests | coating on a PCB board and curing at 120° C. for 15 minutes and left to cool for 12 hours | | | | | | | |
| Tear Strength (N/m) | 4203 | 2080.5 | 3598.9 | 2725.0 | 2989.4 | 1973.7 | 2390.5 | 5856.2 |
| Average peel force (N) | 7.5 | 22.55 | 8.50 | 4.49 | 3.16 | 15.48 | 12.72 | 4.31 |
| Hardness (Shore A) | 13.10 | <8 | 8.7 | 13.1 | 15.2 | 11.3 | 10.8 | 14 |
| Hardness (Shore 00) | | 49 | | | | | | |
| Young's Modulus (Mpa) | | 0.04 | 0.22 | 0.34 | 0.44 | 0.20 | 0.20 | 0.50 |
| Elongation at break (%) | 633 | 822 | 851 | 510 | 473 | 396 | 390 | 747 |
| Residual of silicone | No | No | No | No | No | No | No | No |
| elastomer on substrate | | | | | | | | |
| after peeling off the | | | | | | | | |
| cured silicone elastomer | | | | | | | | |
| from the PCB board | | | | | | | | |
| (Yes/No) | | | | | | | | |
| Failure mode (Adhesive | Adhesive | Adhesive | Adhesive | Adhesive | Adhesive | Adhesive | Adhesive | Adhesive |
| or Cohesive) | | | | | | | | |

TABLE 2
Results of peel force and qualitative analysis for 3 comparative
materials against formulation of Example 1.

| | ESA 7244 | ESA 7242 | ESA 6009 | |
|---|---|---|---|---|
| Properties | Comp.1 | Comp.2 | Comp.3 | Ex.1 |
| Peel Force (N) | 62 | 1 | 4.4 | 7.5 |
| Physical aspect after | Elastomer | Elastomer | Gel | Elastomer |
| curing | | | | |
| Failure mode | Cohesive | Adhesive | Cohesive | Adhesive |
| (Adhesive or | | | | |
| Cohesive) | | | | |
| Residual of silicone | No | No | Yes | No |
| elastomer on substrate | | | | |
| after removal (Yes/No) | | | | |

Adhesion (Qualitative)

| | | | | |
|---|---|---|---|---|
| Integrity of the silicone | Torn | Torn | Torn | One Piece |
| elastomer when | | | | |
| removed | | | | |
| Peel Force | Too High | Too Low | Within | Within |
| | | | Range | Range |

TABLE 3
Formulation in a two-part form for the preparation of a
silicone syntactic foam (mixing 1:1 part by weight)
according to the invention (Example 9).

| | Weight | | Weight |
|---|---|---|---|
| Part A Components | % | Part B: Components | % |
| LSR Base | 28.88% | LSR Base | 28.88% |
| Component A1 | 58.81% | Component A1 | 48.69% |
| Component D | 0.04% | Component C | 1.98% |
| Component E1 | 12.28% | Component E1 | 12.28% |
| | | Component B | 8.14% |
| Total | 100.00% | Component F | 0.03% |

The articles comprising the substrate S coated with compositions which are then cured to silicone elastomers according to the invention showed good adhesion to a PCB substrate and when they were removed by hand they were easily peelable with clean-releasing properties and with adhesive failure properties demonstrating that they can be easily and cleanly removed by human force. This allows a repair or re-use purpose to be efficient, since no cleaning of the surface of the substrate is needed. Furthermore, all the peel force of the cured silicone elastomer Z according to the invention are within a range that is workable for a person to peel off with their own ability.

TABLE 4
Results of example 9 after mixing and curing the formulation
onto substrate S.
Example 9
Properties before curing

| | |
|---|---|
| Ratio: RHalk | 1.2 |
| Ratio: RHCE (%) | 75 |
| Viscosity (mPa · s) just after mixing | 26500 |
| 1:1 by weight of part A and Part B | |

Properties after mixing 1/1 by weight Part-A and B and curing

| | |
|---|---|
| Physical aspect after curing | Silicone syntactic foam |
| Peel Force (N) | 8.4 |
| Hardness (Shore A) | 23.00 |
| Elongation at break (%) | 302 |
| Young's Modulus (Mpa) | 0.23 |
| Failure mode (Adhesive or | Adhesive |
| Cohesive) | |
| Residual of silicone elastomer on | No |
| substrate after removal (Yes/No) | |
| Integrity of the silicone elastomer | One piece |
| when removed | |

The silicone syntactic foam showed good adhesion to a PCB substrate and when it was removed by natural human force, it was easily peelable with clean-releasing adhesive failure. This allows a repair or re-use purpose to be efficient, since no cleaning of surface of the substrate is needed. Furthermore, all the peel force of the cured silicone elastomer Z according to the invention are within a range that is workable for a person to peel off with their own ability.

TABLE 5
Formulations 10 to 18 (components are listed by % weight)

| Examples | 10 | 11 | 12 | 13 | 14 | 15 | 16 | 17 | 18 |
|---|---|---|---|---|---|---|---|---|---|
| Part A | | | | | | | | | |
| LSR base | 32.92 | 32.88 | 32.93 | 33.03 | 32.88 | 13.96 | 23.41 | 47056 | 6.58 |
| Component A1 | 67.04 | 67.08 | 67.03 | 66.94 | 67.09 | 86.00 | 76.55 | 52.40 | 13.41 |
| Component D | 0.04 | 0.04 | 0.04 | 0.04 | 0.04 | 0.04 | 0.04 | 0.04 | 0.01 |
| Component E2 | 0 | 0 | 0 | 0 | 0 | 0 | 0 | 0 | 80 |
| Total part A | 100 | 100 | 100 | 100 | 100 | 100 | 100 | 100 | 100 |
| Part B | | | | | | | | | |
| LSR base | 32.92 | 32.74 | 32.49 | 32.00 | 31.95 | 13.58 | 22.83 | 46.67 | 6.58 |
| Component A1 | 55.51 | 55.25 | 55.88 | 57.12 | 57.47 | 72.93 | 64.79 | 43.81 | 11.10 |
| Component F | 0.03 | 0.03 | 0.03 | 0.03 | 0.03 | 0.03 | 0.03 | 0.03 | 0.007 |
| Component C | 2.26 | 0.46 | 1.37 | 3.15 | 4.04 | 2.72 | 2.49 | 1.92 | 0.45 |
| Component B | 9.28 | 11.52 | 10.23 | 7.70 | 6.51 | 10.74 | 9.86 | 7.58 | 1.86 |
| Component E2 | 0 | 0 | 0 | 0 | 0 | 0 | 0 | 0 | 80 |
| Total Part B | 100 | 100 | 100 | 100 | 100 | 100 | 100 | 100 | 100 |
| RHalk (1:1 by weight | 1.20 | 1.20 | 1.20 | 1.20 | 1.20 | 1.20 | 1.20 | 1.20 | 1.20 |
| of Pa A and Part B) | | | | | | | | | |
| RHCE = | 75 | 95 | 85 | 65 | 55 | 75 | 75 | 75 | 75 |
| nHCE/(nHCE + | | | | | | | | | |
| nHXL) × 100 | | | | | | | | | |

TABLE 6
Formulations 19 to 25 (components are listed by % weight)

| Examples | 19 | 20 | 21 | 22 | 23 | 24 | 25 |
|---|---|---|---|---|---|---|---|
| Part A | | | | | | | |
| Component LSR Base 2 | 32.68 | 32.63 | 32.74 | 32.84 | 13.89 | 23.25 | 46.98 |
| Component A1 | 67.30 | 67.35 | 67.24 | 67.14 | 86.09 | 76.73 | 53.00 |
| Component D | 0.02 | 0.02 | 0.02 | 0.02 | 0.02 | 0.02 | 0.02 |
| Total Part A | 100.00 | 100.00 | 100.00 | 100.00 | 100.00 | 100.00 | 100.00 |
| Part B | | | | | | | |
| Component LSR Base 2 | 32.19 | 32.46 | 31.91 | 31.38 | 13.65 | 22.87 | 46.34 |
| Component A1 | 54.77 | 54.05 | 55.48 | 56.86 | 71.80 | 63.33 | 41.77 |
| Component F | 0.03 | 0.03 | 0.03 | 0.03 | 0.03 | 0.03 | 0.03 |
| Component C | 1.54 | 0.52 | 2.54 | 4.49 | 1.71 | 1.63 | 1.40 |
| Component B | 11.47 | 12.93 | 10.04 | 7.24 | 12.80 | 12.14 | 10.46 |
| Total Part B | 100.00 | 100.00 | 100.00 | 100.00 | 100.00 | 100.00 | 100.00 |
| RHalk (1:1 by weight of | 1.20 | 1.20 | 1.20 | 1.20 | 1.20 | 1.20 | 1.20 |
| Part A and Part B) | | | | | | | |
| RHCE = nHCE/(nHCE + | 85.00 | 95.00 | 75.00 | 55.00 | 85.00 | 85.00 | 85.00 |
| nHXL) × 100 | | | | | | | |

TABLE 7
Mechanical properties of cured elastomers of
examples 10 to 18.

| | Tear | | | | | |
|---|---|---|---|---|---|---|
| | Strength | | Peel Force | | Hardness | |
| Examples | N/m | lbf | N | lbf | Shore A | Shore 00 |
| 10 | 2081 | 12 | 22.55 | 5.07 | <8 | 49 |
| 11 | 3599 | 21 | 8.50 | 1.91 | 9 | |
| 12 | 2725 | 16 | 4.49 | 1.01 | 13 | |
| 13 | 2989 | 17 | 3.16 | 0.71 | 15 | |
| 14 | 1974 | 11 | 15.48 | 3.48 | 11 | |
| 15 | 2390 | 14 | 12.72 | 2.86 | 11 | |
| 16 | 5856 | 33 | 4.31 | 0.97 | 14 | |
| 17 | 4203 | 24 | 8.90 | 2.00 | 13 | |
| 18 | 664 | 4 | 14.37 | 3.23 | 48 | |

TABLE 8
Mechanical properties of cured elastomers of examples 10 to 18.

| | | | | | | Integrity of |
|---|---|---|---|---|---|---|
| | | | | | | the silicone |
| | | | Max | Young's | Failure mode | elastomer when |
| Exam- | Max Stress | | Strain | Modulus | (Adhesive or | removed (One |
| ples | Mpa | psi | % | MPa | Cohesive) | Piece or torn) |
| 10 | 0.2 | 33 | 822 | 0.0 | adhesive | Torn |
| 11 | 1.3 | 190 | 851 | 0.2 | adhesive | One piece |
| 12 | 1.2 | 172 | 510 | 0.3 | adhesive | One piece |
| 13 | 1.4 | 209 | 473 | 0.4 | adhesive | One piece |
| 14 | 0.5 | 79 | 396 | 0.2 | adhesive | Torn |
| 15 | 0.5 | 79 | 390 | 0.2 | adhesive | One piece |
| 16 | 2.6 | 371 | 747 | 0.5 | adhesive | One piece |
| 17 | 1.4 | 208 | 621 | 0.3 | adhesive | One piece |
| 18 | 0.7 | 103.0 | 241 | 0.4 | adhesive | One piece |

TABLE 9
Mechanical properties of cured elastomers of examples 19 to 25.

| | Tear Strength | | Peel Force | | Hardness | |
|---|---|---|---|---|---|---|
| Examples | N/m | lbf | N | lbf | Shore A | Shore 00 |
| 19 | 8 | 1.1 | 152 | 849 | 0.2 | 8 |
| 20 | 15 | 1.7 | 249 | 459 | 0.5 | 15 |
| 21 | 10 | 1.0 | 145 | 512 | 0.3 | 10 |
| 22 | 12 | 0.4 | 64 | 350 | 0.2 | 12 |
| 23 | 13 | 0.8 | 120 | 509 | 0.2 | 13 |
| 24 | 14 | 2.3 | 336 | 627 | 0.5 | 14 |
| 25 | 9 | 1.2 | 174 | 531 | 0.3 | 9 |

TABLE 10
Mechanical properties of cured elastomers of examples 19 to 25.

| | | | | | | Integrity of |
|---|---|---|---|---|---|---|
| | | | | | | the silicone |
| | | | Max | Young's | Failure mode | elastomer when |
| Exam- | Max Stress | | Strain | Modulus | (Adhesive or | removed (One |
| ples | Mpa | psi | % | MPa | Cohesive) | Piece or torn) |
| 19 | 6.4 | 4.5 | 456.4 | 6.4 | adhesive | One piece |
| 20 | 2.2 | 1.5 | 150.2 | 2.2 | adhesive | One piece |
| 21 | 1.5 | 1.9 | 195.8 | 1.5 | adhesive | One piece |
| 22 | 6.6 | 3.4 | 344.7 | 6.6 | adhesive | Torn |
| 23 | 12.2 | 4.1 | 413.7 | 12.2 | adhesive | Torn |
| 24 | 17.0 | 4.0 | 407.6 | 17.0 | adhesive | One piece |
| 25 | 11.1 | 6.5 | 663.8 | 11.1 | adhesive | One piece |

Silicone elastomers according to the invention coated to the substrate S showed good adhesion to such PCB substrate and when they were removed by hand they were easily peelable with clean-releasing properties and with adhesive failure properties demonstrating that they can be easily and cleanly removed by human force. This allowed a repair or re-use purpose to be efficient, since no cleaning of the surface of the substrate was needed. Furthermore, all the measured peel force of the cured silicone elastomer Z coated on the tested substrate are within a range (1.5N to 23 N) that is workable for a person to peel off with their own ability. Furthermore, all the silicone elastomers according to the invention gave no residual of silicone elastomer on substrate after removal.

We claim:

1. An article comprising a substrate S in contact with a cured silicone elastomer Z with adhesive properties to various substrates and which is peelable with clean-releasing properties and wherein said cured silicone elastomer Z is prepared upon mixing and curing a curable liquid silicone composition X which is preferably stored as a two-part curable liquid silicone composition comprising a first liquid composition comprising components (A), (B), (C), (E), and eventually (F), but not (D) and a second liquid composition comprising components (A), (E), and (D), but not (B) and not (C) and not (F), wherein the first liquid composition and the second liquid composition are stored separately and comprising components:
(A) 100 parts by weight of at least one alkenyl group-containing organopolysiloxane A having at least two silicon-bonded alkenyl groups per molecule,
(B) at least one diorganohydrogensiloxy-terminated polydiorganosiloxane CE,
(C) at least one organosilicon crosslinker XL containing at least 3 silicon-bonded hydrogen atoms per molecule,
(D) at least one addition reaction catalyst D, and
(E) from 1 to 500 parts by weight of at least one filler E,
(F) from 0 to 10 parts by weight of at least one cure rate modifier F,
wherein component (A) can be the same or different in the first and second liquid compositions, and wherein component (E) can be the same or different in the first and second liquid compositions,
wherein the amounts of the alkenyl group-containing organopolysiloxane A, the diorganohydrogensiloxy-terminated polydiorganosiloxane CE, and the organosilicon crosslinker XL are determined such that:
1) the value of the ratio RHalk is 1.00<RHalk<1.35, wherein RHalk=nH/tAlk, and wherein:
nH=number of moles of hydrogen atom directly bonded to a silicon atom of said liquid silicone composition X; and
tAlk=number of moles of alkenyl groups directly bonded to a silicon atom of said liquid silicone composition X, and
2) the % molar ratio RHCE is within the range of 50%≤RHCE<98%, wherein RHCE−nHCE/(nHCE+nHXL)×100, and wherein:
a) nHCE is the number of moles of hydrogen atom directly bonded to a silicon atom of the diorganohydrogensiloxy-terminated polydiorganosiloxane CE, and
b) nHXL=is the number of moles of hydrogen atom directly bonded to a silicon atom of the organosilicon crosslinker XL.

2. The article according to claim 1 wherein the value of the ratio RHalk is 1.10≤RHalk<1.25.

3. The article according to claim 1 wherein the cured silicone elastomer Z has a 180° peel adhesion to an epoxy fiberglass board within the range of 1.5N to 23N and preferably from 3N to 23 N.

4. The article according to claim 1 wherein the cured silicone elastomer Z have an elongation-at-break value of at least 300% measured according to ASTM D-412.

5. The article according to claim 1 wherein the contact between the substrate S and the cured silicone elastomer Z is done either by potting or encapsulating, coating, applying or spraying the curable liquid silicone composition X onto the substrate S and then curing it to obtain the cured silicone elastomer Z, or by potting or dipping the substrate S with said curable liquid silicone composition X and then curing it to obtain the cured silicone elastomer Z.

6. The article according to claim 1 wherein the substrate S is chosen from group consisting of an element of a printed circuit board, an element of an electronic device, an element of a secondary battery pack and an element of a photovoltaic solar panels.

7. The article according to claim 1, wherein said organosilicon crosslinker XL containing at least 3 silicon-bonded hydrogen atoms per molecule is an organohydrogenpolysiloxane comprising from 10 to 500 silicon atoms within each molecule, and wherein ratio α is within the range 0.01≤α≤0.957,
wherein α=d/(ΣSi), and wherein:
d=number of H atoms directly linked to a Si atom per molecule, and
ΣSi is the sum of silicon atoms per molecule.

8. The article according to claim 1, wherein said organosilicon crosslinker XL containing at least 3 silicon-bonded hydrogen atoms per molecule is an organohydrogenpolysiloxane comprising from 10 to 500 silicon atoms within each molecule, and wherein the organohydrogenpolysiloxane comprises from 0.45-40% SiH by weight.

9. The article according to claim 1, wherein said organosilicon crosslinker XL comprises:
(i) at least 3 siloxy units of formula (XL-1) which may be identical or different:
(H)(Z)ₑSiO_{(3-e)/2} (XL-1)
wherein:
the symbol H represents a hydrogen atom,
the symbol Z represents an alkyl having from 1 to 8 carbon atoms inclusive, and
the symbol e is equal to 0, 1 or 2; and
(ii) at least one, and preferably from 1 to 550 of siloxy unit(s) of formula (XL-2):
(Z)_{g}SiO_{(4-g)/2} (XL-2)
wherein:
the symbol Z represents an alkyl having from 1 to 8 carbon atoms inclusive, and
the symbol g is equal to 0, 1, 2 or 3;
wherein Z in XL-1 and XL-2 can be the same or different.

10. The article according to claim 7, wherein said organosilicon crosslinker XL comprises from 3 to 60 siloxy units of formula (XL-1) and from 1 to 250 siloxy unit(s) of formula (XL-2).

11. The article according to claim 1, wherein said organosilicon crosslinker XL containing at least 3 silicon-bonded hydrogen atoms per molecule is an organohydrogenpolysiloxane comprising from 10 to 250 silicon atoms within each molecule and wherein ratio α is within in the range of 0.10≤α≤0.75.

12. The article according to claim 1, wherein the diorganohydrogensiloxy-terminated polydiorganosiloxane CE is of the following formula (2): 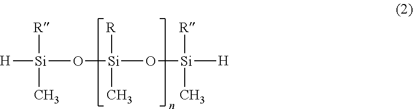
wherein:
R and R″ are independent and are selected from a C₁ to C₂₀ alkyl group, and
n is an integer ranging from 1 to 500.

13. The article composition according to claim 1 further comprising:
(G) from 0 to 2 parts by weight of at least one thickener G1 or at least one rheology modifier G2, and/or
(H) from 0 to 10 parts of at least one additive H.

14. The article according to claim 1 wherein the filler E is selected from the group consisting of a reinforcing filler E1, a thermally conductive filler E2, an electrically conductive filler E3, hollow glass beads E4 and mixtures thereof.

15. The article according to claim 1 wherein the cured silicone elastomer Z is a silicone syntactic foam comprising hollow glass beads E4.

16. The article according to claim 15 wherein the level of hollow glass beads E4 in the silicone syntactic foam is up to 50% volume loading.

17. A recycling method comprising the steps of:
a) providing an article according to claim 1,
b) peeling off the cured silicone elastomer Z from the support S, and then
c) recycling or re-using said article.

18. A recycling method according to claim 17 wherein the article is a printed circuit board, an electronic device, a secondary battery pack or a photovoltaic solar panel.

19. A recycling method according to claim 17 wherein the article is a secondary battery pack comprising a substrate S in contact with a cured silicone elastomer Z which is a silicone syntactic foam comprising hollow glass beads E4.

20. A recycling method according to claim 17 comprising the steps of:
a) providing an article which is a secondary battery pack comprising a substrate S in contact with a cured silicone elastomer Z which is a silicone syntactic foam comprising hollow glass beads E4,
b) peeling off the cured silicone elastomer Z from the support S, and then
c) re-using said secondary battery pack for stationary energy storage.
